(19) United States
(12) Patent Application Publication
(10) Pub. No.: US 2006/0149814 A1
(43) Pub. Date: Jul. 6, 2006

(54) METHOD AND APPARATUS FOR PRESENCE STATUS FACILITATION BY AN ACCESS GATEWAY IN A MOBILE COMMUNICATIONS SYSTEM

(75) Inventor: Michael S. Borella, Naperville, IL (US)

Correspondence Address: PATENTS AND LICENSING LLC;DANIEL W. JUFFERNBRUCH, 28 BARRINGTON BOURNE, BARRINGTON, IL, 60010-9605, US

(73) Assignee: UTSTARCOM, INC., Alameda, CA (US)

(21) Appl. No.: 10/905,378

(22) Filed: Dec. 30, 2004

(51) Int. Cl. G06F 15/16

(52) U.S. Cl. 709/204; 709/227

(57) ABSTRACT

A communications system is capable of knowing presence status of mobile communications devices such as cellular transceivers. An access gateway such as, for example, a PDSN access gateway or home agent access gateway, manages access to a mobile communications device. The access gateway knows the presence status of the mobile communications device and reports it to a presence server. The access gateway can know the presence status using attributes obtained during management of system operation by the access gateway.

### BACKGROUND OF THE INVENTIONS

1. Technical Field

The present inventions relate to presence communications and, more particularly, relate to communications systems having presence awareness.

2. Description of the Related Art

Presence, availability and location (PAL) services require that a networked presence entity such as a presence server, is informed with information about the status of a device, application, or user. This information can be queried, polled, or pushed to watcher devices in order for the watchers to make intelligent decisions about when, where, and how to deliver information to the presence entity.

Presence and availability services are implemented in a basic form in some of the instant messaging applications available today. These programs allow a user to establish a “buddy list” of other users. When the user turns on the instant messaging application, he becomes “present”. If he has configured his client to do so, he is also indicated as “available”. However, he may change his presence and availability status depending if he goes off line, or becomes busy. If he has been idle for a period of time, the instant messaging client may automatically mark the user as idle.

The Internet Engineering Taskforce (IETF) as published some Requests for Comments (RFC) and an internet draft on presence used in Instant Messaging (IM) and the Session Initiation Protocol (SIP). M. Day, et. al. published “A Model for Presence and Instant Messaging,” Internet RFC 2778, in February 2000. M. Day, et. al. also published “Instant Messaging/Presence Protocol Requirements,” Internet RFC 2779, in February 2000. J. Rosenberg published “A Presence Event Package for the Session Initiation Protocol (SIP),” Internet draft draft-ietf-simple-presence-10.txt, on Jan. 31, 2003.

Currently presence, availability and location (PAL) services are mostly used to notify other users of a user's status. However, these capabilities are being enhanced to include device and application presence, as well as location services. For mobile users, location is a potentially beneficial enhancement.

The presence entity currently sends out messages to publish its presence status to the presence servers and watchers. What is needed is a more efficient way for a presence entity to make its presence status known.

### SUMMARY OF THE INVENTIONS

An object of the present inventions is to provide amore efficient way for a presence entity to make its presence status known.

Another object of the present inventions is to provide a way for a presence entity to publish its presence status without creating additional network traffic.

A further object of the present inventions is to utilize knowledge already existing in network equipment and reduce presence demands on a presence entity.

An additional object of the present inventions is to utilize an access gateway to handle presence communications with a presence entity and a presence server.

A communications system is capable of knowing presence status of mobile communications devices such as cellular transceivers. An access gateway such as, for example, a PDSN access gateway or home agent access gateway, manages access to a mobile communications device. The access gateway knows the presence status of the mobile communications device and reports it to a presence server. For mobile IP the access gateway is either the PDSN or the home agent.

The access gateway can know the presence status using attributes obtained during management of system operation by the access gateway. The presence server receives the presence status for the mobile communications device without querying the mobile communications device. The access gateway may query the mobile communications device on a predetermined schedule to obtain presence status of the mobile communications device. The presence server can alternatively initiate a query of the access gateway for presence status of the mobile communications device, perhaps on a predetermined schedule. The access gateway knows the presence status of the mobile communications device by storing attributes from the mobile communications device. The access gateway can obtain presence data from a radio access network. The presence server receives the presence status for the mobile communications device by obtaining some of the attributes from the mobile communications device from the access gateway. The access gateway at a home network, known as a home agent, can hold attributes.

The details of the preferred embodiments and these and other objects and features of the inventions will be more readily understood from the following detailed description when read in conjunction with the accompanying drawings wherein:

### BRIEF DESCRIPTION OF THE DRAWINGS

FIG. 1 illustrates a schematic block diagram of a presence entity, a presence aggregator, a presence server and one or more watchers according to the present inventions;

FIG. 2 illustrates a schematic block diagram of a mobile communications system having presence awareness according to the present inventions;

FIG. 3 illustrates flow diagrams of three exemplary call flows for presence reporting from a home agent access gateway in the communications system of the present inventions; and

FIG. 4 illustrates flow diagrams of three exemplary of call flows for presence reporting from a PDSN access gateway in the communications system of the present inventions.

### DETAILED DESCRIPTION OF THE PREFERRED EMBODIMENTS

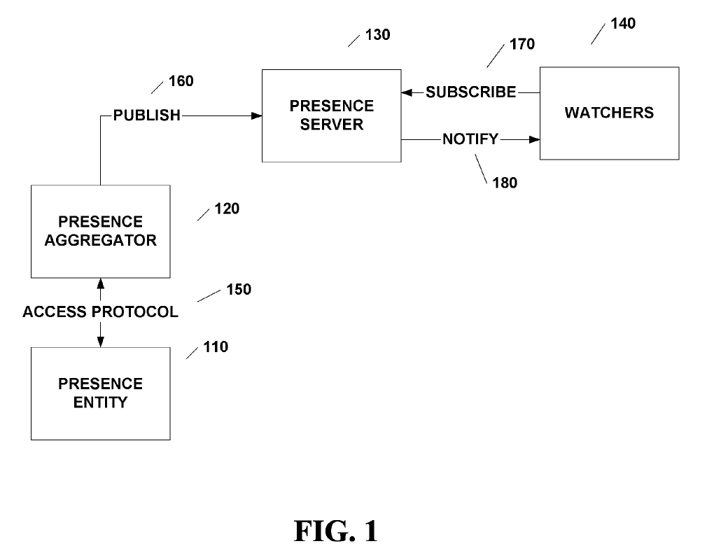

FIG. 1 illustrates a schematic block diagram of a presence entity 110, a presence aggregator 120, a presence server 130 and one or more watchers 140 according to the present inventions. These components simply make-up the presence architecture. The presence entity 110 is the entity whose presence is being monitored. The presence entity 110, can be any device, application, or user, and is represented by a mobile transceiver according to the preferred embodiment. The mobile transceiver can be a mobile cellular radio or radiotelephone.

The presence entity 110 communicates over an access protocol 150 with the presence aggregator 120, which according to the preferred embodiments is an access gateway. In the preferred embodiments, the presence aggregator 120 is an access device, such as a PDSN or a HA or a GGSN, but its function is not limited to these roles. A PDSN is a Packet Data Serving Node PDSN, a HA is a Home Agent and a GGSN is a GPRS (General Pack Data Service) Serving Node. The presence aggregator 120 may collect and publish presence status multiple presence servers 130.

By presence status in the present inventions, applicant means the status of one or more of the statuses selected from the group consisting of presence, availability and location (PAL). The presence, availability and location (PAL) statuses, with respect to a presence entity such as a mobile transceiver, can be defined as follows:
Presence identifies whether or not the presence entity such as a mobile transceiver is on the network, and if it is, its preferred methods of contact, such as email addresses, phone numbers, URL's, etc. Presence is a set of attributes characterizing current properties of presence entities such as status, an optional communication address and other optional attributes etc.
Availability identifies whether the presence entity is available for a particular type of session. For example, it identifies, if a presence entity is on a phone call, it may be available for instant messaging, but not telephony services. Availability is a property of a presence entity denoting its ability and willingness to communicate based on factors such as the identity or properties of the watcher and the preferences and/or policies that are associated with the presence entity.
Location identifies the physical or location of the presence entity such as a mobile transceiver. Location is a representation of the physical or virtual location of a presence entity.

Note that the presence entity 110 may have control over which watcher 140 sees any of this information. For example, a presence entity 110 may allow only certain groups of watchers 140 to know its availability.

The presence aggregator 120 may also be a third party that publishes PAL information of the presence entity on its behalf.

The presence server 130 receives published information 160 from the presence aggregator 120, and stores this information in a local database. The presence server 130 can receive published information 160 from more than one presence aggregator 120. The presence server 130 also allows watchers 140 to request presence status of one or more presence entities 110. In other words, a watcher 140 can subscribe to the presence status of a device and the presence server 130 may notify the watcher when this status changes.

The presence server 130 may allow the presence entity 110 or the presence aggregator 120 to determine the privacy level of its PAL information. For example a presence entity 110 may be able to indicate to the presence server 130 that its entire presence status, or parts of its presence status, can be seen by only certain watchers 140. Then the presence server 130 must authenticate watchers 140 that request this presence status.

Watchers 140 can subscribe to the presence status of a presence entity 110 via the presence server 130. Several types of watchers 140 may exist. Subscribing watchers 140 subscribe 170 to the presence status of a presence entity 110 and then waits to be notified 180 of events by the presence server 130. Polling watchers 140, on the other hand, periodically request an update of the presence status of a presence entity 110. Polling watchers 140 are more efficient on wireless networks where bandwidth is limited and the watcher 140 wants some control over the volume of information sent.

Presence and availability services are considered for third generation cellular systems such as CDMA2000. The CDMA2000 system contains an access gateway known as the Packet Data Serving Node (PDSN) and defined in the CDMA2000 Wireless IP Standard, TIA/EIA IS-835-B, of September 2002.

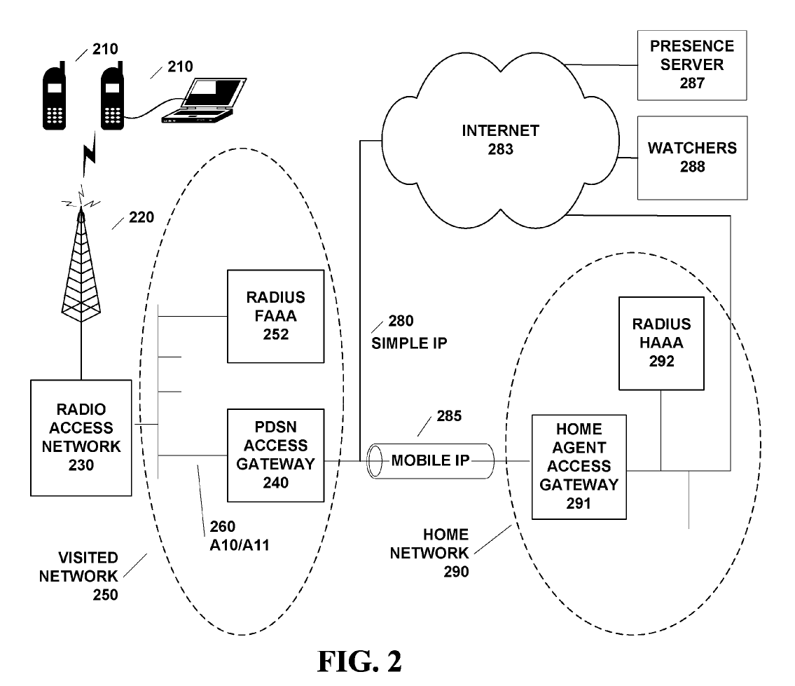

FIG. 2 illustrates a schematic block diagram of a mobile communications system having presence awareness according to the present inventions. A CDMA2000 communications system architecture is illustrated in the preferred embodiment of FIG. 2. Voice and data mobile devices 210 connect through a wireless channel 220 and a radio access network (RAN) 230 to an access gateway such as a packet data serving node (PDSN) access gateway 240 in a visited network 250. A mobile user session is encapsulated in PPP, and then tunneled over an A10/A11 interface 260, which uses GRE encapsulation.

There are two types of calls, simple IP and mobile IP. Simple IP calls follow path 280 and provide basic IP network access, with the mobile being assigned an IP address from the visited network. If a mobile using simple IP roams to a new RAN, it is likely to be assigned a different PDSN access gateway 240 and therefore assigned a new IP address, breaking any data transfer in progress. Mobile IP calls follow path 285 and allow an IP address to be assigned by a home network 290 and kept by a mobile device 210 as it roams across RANs. A mobile IP call will maintain application state and data transfer between handoffs, enhancing the overall user experience. Mobile IP calls are tunneled between the PDSN access gateway 240 and a home agent access gateway 291 using either IP-in-IP, GRE, or Ipsec.

Both simple IP and mobile IP types of calls are authenticated by the authentication, authorization and accounting (AAA) infrastructure, which consists of a foreign AAA (RADIUS FAAA) 252 and a home AM (RADIUS HAAA) 292. The user's profile and associated information resides in the RADIUS HAAA 292, so the RADIUS FAAA 252 proxies requests and responses between the PDSN access gateway 240 and the RADIUS HAAA 292. The home agent access gateway 291 may also communicate with the RADIUS HAAA 292 directly for a further round of authentication, if necessary, or to acquire an IP address for the mobile device 210.

Both simple IP and mobile IP calls connect to the internet 283. This is where a presence server 287 connects to obtain the presence information for either the simple IP or mobile IP access gateways. In the case of simple IP, the access gateway is the PDSN access gateway 240. In the case of mobile IP, the access gateway is made up of both the home agent 291 and the access gateway PDSN 240 acting together on the two sides of the mobile IP tunnel 285. Watchers 288 obtain presence status from the presence server 287 over the internet as well. The presence server 287 and the watchers 288 can alternatively be connected more directly to the simple IP or mobile IP data behind their respective PDSN access gateway 240 or home agent access gateway 291 for security or other reasons. An alternate connection is over the wide area network of the internet 283 as illustrated in the embodiment of FIG. 2.

In the CDMA2000 network, a presence server 287 may exist either behind the PDSN access gateway 240, for simple IP, or behind the home agent access gateway 291, for mobile IP. Being in the core network would allow it to receive input from a number of presence entities as well as access gateways, such as the PDSN access gateway 240 and home agent access gateway 291. Presence capability is thus facilitated in the communications system of the present inventions by these access gateways. The presence status of a mobile device 210 is thus provided to the presence server 287 by facilitation of an access gateway thus improving network utilization.

While the embodiment of FIG. 2 exemplifies a general CDMA2000 network, there are many variations that can be deployed commercially. In fact, every service provider their own unique architecture based on their technical and business requirements. Some networks are simple IP only, while others support both simple IP and mobile IP. Some network architectures are centralized, with PDSNs and home agents co-located in one or more points of presence, while others employ a distributed architecture. Furthermore, the visited and home networks may be the same network, may be different networks operated by the same service provider, or may be different networks operated by different service providers.

Reporting of presence status in a CDMA2000 network may occur on the home agent access gateway 291 or the PDSN access gateway 240. We will discuss each case in detail. In CDMA2000, it may be useful to track presence status on behalf of a mobile device not only to enable communications to and from the mobile device, but to also gather detailed network usage statistics and track mobile node behavior for purposes of lawful electronic surveillance.

In the case of the home agent access gateway 291, the home agent access gateway may report presence status to the presence server 287 on behalf of a mobile device 210. The following attributes of presence status can be published at the presence server 287:
Network Access Identifier (NAI): The email address of the mobile device,
assigned IP address(es) of the mobile device,
the total duration of the mobile device's registration at the home agent access gateway,
the remaining duration of the mobile device's registration at the home agent access gateway,
the IP address of the PDSN access gateway by which the mobile device is current being served,
the number of PDSN access gateway handoffs that the mobile device has experienced in this session,
whether or not the mobile device is using an IPsec tunnel that is either terminating at or passing through the home agent access gateway, and
additional attributes as become available in future access gateway architectures.

In general, the home agent access gateway may provide presence information on behalf of a mobile device based on any information that the home agent access gateway stores with respect to that mobile device. This includes the mobile IP mobility binding record (MBR), the AAA profile, and other information. We refer to the aggregate of information that the home agent access gateway can report to the presence server as the home agent access gateway (HA) Presence Data Record, or HA-PDR.

The home agent access gateway may update the presence server using at least two different methods: triggered updates and timer-based updates. Triggered updates are sent when the presence status of a presence entity such as a mobile device changes, for example, when a mobile device registers with the home agent access gateway. Timer based updates are sent periodically, and only include the changes in the presence status of all of the presence entities served by the home agent access gateway since the same update. Some combination of triggered and timer-based updates may be used.

The home agent access gateway may determine whether or not to transmit presence information on behalf of the mobile device depending on local configuration, or on attributes returned from the RADIUS HAAA.

In the case of the PDSN access gateway, the PDSN access gateway 240 may report the presence status to the presence server 287 on behalf of a mobile device 210. The following attributes of presence status can be published at the presence server 287:
dormancy status (dormant or active),
length of dormancy, if dormant,
Network Access Identifier (NAI): The email address of the mobile device,
assigned IP address(es) of the mobile device,
whether or not the mobile device is using mobile IP instead of simple IP,
the number of simple IP and mobile IP sessions in use by the mobile device,
the amount of time that the mobile device has been logged on,
the International Mobile Subscriber Identifier (IMSI) of the mobile device,
the signal strength of the mobile device,
the Electronic Serial Number (ESN) of the mobile device,
Serving Packet Control Function (PCF) that the mobile device is attached to,
base station ID from the serving base station that the mobile is attached to, and sector ID & cell ID,
service option(s) associated with this mobile's session(s)
serving home agent (if applicable),
whether or not a P-P session is being used,
whether or not IPsec is being used,
geographical coordinates,
Network Access Server (NAS) ID of PDSN to determine carrier, and
additional attributes as become available in future access gateway architectures.

In general, the PDSN access gateway 240 may provide presence status on behalf of a mobile device based on any information that the PDSN stores with respect to that mobile device. This includes any information received from the radio access network 230 over an A10/A11 interface, the AAA profile, and other information. Thus the access gateway efficiently provides presence status information to a presence server using the attributes already managed by the access gateway without additional network burden querying for or deriving that status information. We refer to the aggregate of information that the PDSN access gateway can report to the presence server as the PDSN Presence Data Record, or PDSN-PDR.

The PDSN access gateway may update the presence server using at least two different methods: triggered updates and timer-based updates. Triggered updates are sent when the presence status of a presence entity such as a mobile device changes, for example, when a mobile device registers with the PDSN. Timer based updates are sent periodically, and only include the changes in the presence status of all of the presence entities served by the PDSN since the same update.

The PDSN may determine whether or not to transmit presence information on behalf of the mobile depending on local configuration, or on attributes returned from the home AAA server.

When an access gateway 240 or 291 obtains the presence status of a mobile device 210, it will typically not need to query the mobile device 210. The presence status can be obtained by the access gateway from attributes within the access gateway or obtained from the Radio Access Network (RAN) 230.

Although the presence server receives the presence status for the mobile communications device without querying, the access gateway can query the mobile communications device on a predetermined schedule to obtain its presence status. This query can be initiated by the presence server or by the presence server in response to a request from a watcher. Alternatively this query of the access gateway for presence status of the mobile communications device can occur on a predetermined schedule.

Because the presence status of a user and the presence status of an application reside on a mobile communications device, the presence status of a mobile communications device can represent the status of the user using the device or the application on the device. The mobile communications device is the presence entity for devices, as well as users and applications.

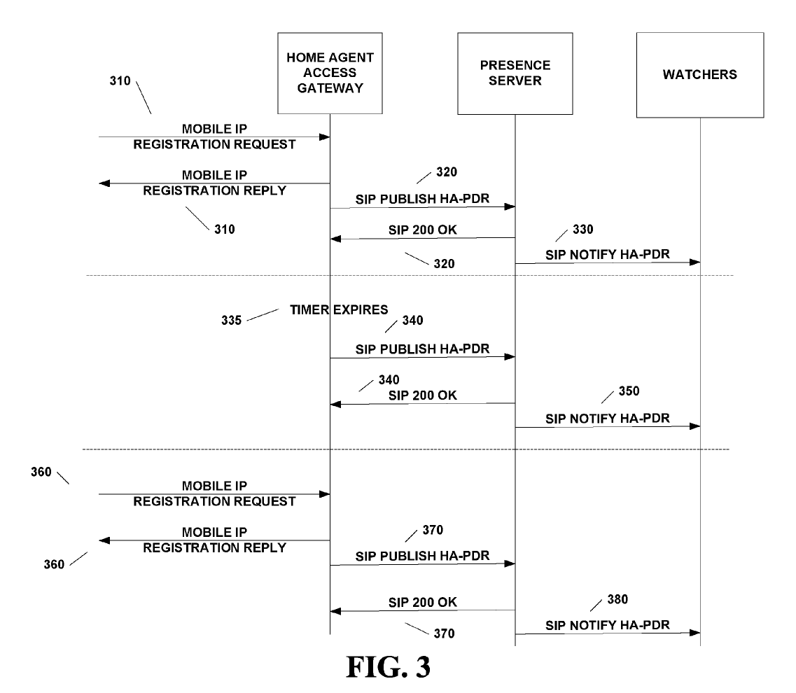

FIG. 3 illustrates flow diagrams of three exemplary call flows for presence reporting from a home agent access gateway in the communications system of the present inventions. In a first call flow, the home agent access gateway receives a mobile IP registration request 310 that is either a new registration or a renewal of an old registration for a particular user. This may trigger the home agent access gateway to send 320 the user's HA-PDR to the presence server. The presence server may then send a presence update 330 to any of the appropriate watchers. In a second call flow, the presence update timer expires 335, triggering the home agent access gateway to send 340 one or more mobile device's HA-PDRs to the presence server. The presence server may then send a presence update 350 to any of the appropriate watchers. In a third call flow, the home agent access gateway receives a mobile IP de-registration request 360 (or the call terminates for a different reason) for a particular mobile device. This triggers the home agent access gateway to send 370 the user's HA-PDR to the presence server. The presence server may then send a presence status update 380 to any of the appropriate watchers.

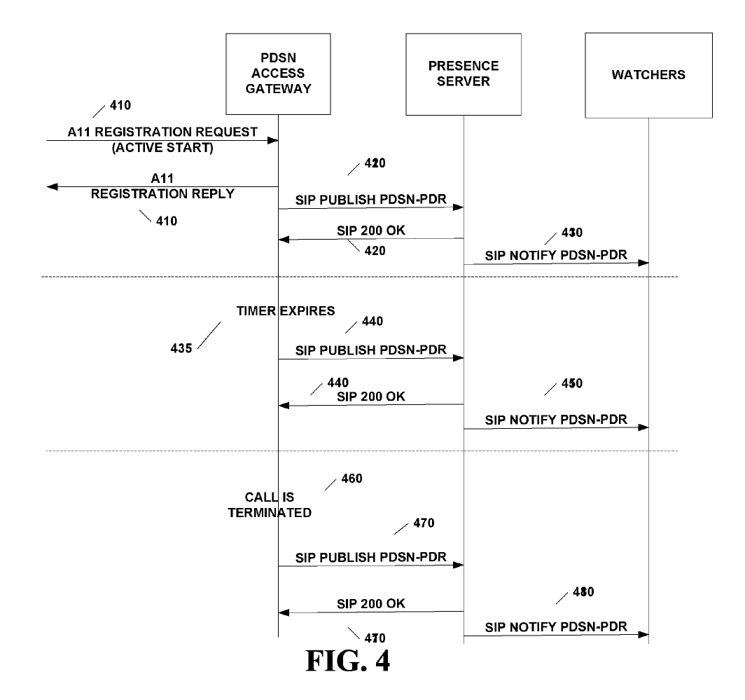

FIG. 4 illustrates flow diagrams of three exemplary call flows for presence reporting from a PDSN access gateway in the communications system of the present inventions. In a first call flow, the PDSN access gateway receives an A11 registration request 410 that is either a new registration or a renewal of an old registration for a particular mobile device. This may trigger the PDSN access gateway to send 420 the mobile device's PDSN-PDR to the presence server. The presence server may then send a presence update 430 to any of the appropriate watchers. In a second call flow, the presence status update timer expires 435, triggering the PDSN access gateway to send 440 one or more mobile device's PDSN-PDRs to the presence server. The presence server may then send a presence update 450 to any of the appropriate watchers. In a third call flow, the PDSN access gateway receives an A11 de-registration request (or the call terminates 460 for a different reason) for a particular mobile device. This triggers the PDSN access gateway to send 470 the mobile device's PDSN-PDR to the presence server. The presence server may then send a presence update 480 to any of the appropriate watchers.

Although the inventions have been described and illustrated in the above description and drawings, it is understood that this description is by example only, and that numerous changes and modifications can be made by those skilled in the art without departing from the true spirit and scope of the inventions. Although the examples in the drawings depict only example constructions and embodiments, alternate embodiments are available given the teachings of the present patent disclosure. For example, the inventions are applicable to wireless LAN or also wireline communications.

What is claimed is:

1. A communications system capable of knowing presence status of mobile communications devices, comprising:
an access gateway for managing access to a mobile communications device, wherein the access gateway knows the presence status of the mobile communications device; and
a presence server operatively connected to the access gateway to receive the presence status for the mobile communications device.

2. A communications system according to claim 1, wherein the access gateway comprises a packet data serving node.

3. A communications system according to claim 1, wherein the access gateway comprises a GPRS serving node.

4. A communications system according to claim 1, wherein the mobile communications device comprises a cellular transceiver.

5. A communications system according to claim 1, wherein the access gateway knows the presence status of applications on the mobile communications device.

6. A communications system according to claim 1, wherein the presence server receives the presence status for the mobile communications device without querying the mobile communications device.

7. A communications system according to claim 1, wherein the access gateway queries the mobile communications device on a predetermined schedule to obtain presence status of the mobile communications device.

8. A communications system according to claim 1, wherein the presence server initiates a query of the access gateway for presence status of the mobile communications device.

9. A communications system according to claim 1, wherein the presence server initiates a query of the access gateway for presence status of the mobile communications device on a predetermined schedule.

10. A communications system according to claim 1, wherein a radio access network provides presence data to the access gateway.

11. A communications system according to claim 1, wherein the access gateway knows the presence status of the mobile communications device by storing attributes from the mobile communications device.

12. A communications system according to claim 11, wherein the presence server receives the presence status for the mobile communications device by obtaining some of the attributes from the mobile communications device from the access gateway.

13. A communications system according to claim 11,
wherein the access gateway stores attributes while managing access to the mobile communications device; and
wherein the presence status of the mobile communications device is based on the attributes.

14. A communications system according to claim 1, wherein the access gateway at a home network holds attributes.

15. A method in an access gateway for facilitating the transmission of presence status of mobile communications devices in a communications system, said method comprising the steps of:
(a) managing access to a mobile communications device,
(b) learning the presence status of the mobile communications device; and
(c) transmitting the presence status for the mobile communications device to a presence server in the communications system.

16. A method in an access gateway according to claim 15, wherein said step (c) of transmitting the presence status for the mobile communications device to a presence server occurs on a predetermined schedule.

17. A method in an access gateway according to claim 15, further comprising the step of (d) receiving a request for presence status of the mobile communications device from the presence server.

18. A method in an access gateway according to claim 15, wherein said step (b) of learning the presence status of the mobile communications device comprises the substep of receiving presence data from a radio access network.

19. A method in an access gateway according to claim 15,
wherein said step (a) of managing access to a mobile communications device comprises the substeps of (a1) accessing the mobile communications device; and (a2) storing attributes for the mobile communication device based on the access in step (a1); and
wherein said step (b) of learning the presence status of the mobile communications device comprises the substep of knowing the presence status of the mobile communications device based on the attributes from the mobile communications device stored in said step (a2).

20. A method in an access gateway according to claim 15,
wherein said step (b) of learning the presence status of the mobile communications device comprises the substep of accessing stored attributes from the mobile communications device; and
wherein said step (c) of transmitting the presence status for the mobile communications device to a presence server in the communications system comprises the substep of transmitting at least one attribute from the access gateway to the presence server.

21. A method in an access gateway according to claim 15,
wherein said step (a) of managing access to the mobile communications device obtains attributes for the mobile communications device while managing; and
wherein said step (b) of learning the presence status of the mobile communications device learns the presence status based on the attributes.

22. A method in a presence server for obtaining the presence status of mobile communications devices in a communications system, said method comprising the steps of:
(a) receiving the presence status of the mobile communications device from an access gateway in the communications system;
(b) storing the presence status of the mobile communications device; and
(c) managing presence status information among elements of the communications system based on the stored presence status of the mobile communications device.
